(19) United States
(12) Patent Application Publication
(10) Pub. No.: US 2021/0223107 A1
(43) Pub. Date: Jul. 22, 2021

(54) POLARIZED LIGHT 3D IMAGE MEASURING INSTRUMENT AND MANUFACTURING METHOD THEREOF

(71) Applicants: Interface Technology (ChengDu) Co., Ltd., Chengdu (CN); Interface Optoelectronics (ShenZhen) Co., Ltd., Shenzhen (CN); General Interface Solution Limited, Miaoli County (TW)

(72) Inventors: Yu-Jen WANG, Miaoli County (TW); Huai-An HSIEH, Miaoli County (TW); Yi-Hsin LIN, Miaoli County (TW); Po-Lun CHEN, Miaoli County (TW); Chun-Ta CHEN, Miaoli County (TW); Ta-Jen HUANG, Miaoli County (TW); Yi-Lin SUN, Miaoli County (TW)

(21) Appl. No.: 16/789,648

(22) Filed: Feb. 13, 2020

(30) Foreign Application Priority Data
Jan. 17, 2020 (CN) 202010052450.0

(51) Int. Cl. G01J 4/04; G02F 1/1335; G02F 1/1341; H04N 13/207

(52) U.S. Cl. CPC G01J 4/04; G02F 1/133528; G02F 2001/133548; H04N 13/207; G02F 2001/13415; G02F 1/1341

(57) ABSTRACT

An instrument for measuring polarized light 3D images and a manufacturing method thereof comprises an image sensor, a liquid crystal cell, and a polarizing plate. The polarizing plate comprises at least four quadrants and is disposed on top of the image sensor. When the polarization state of light is sensed, the image sensor captures and calculates four detection parameters to determine Stokes parameters S₀˜S₃, S₀=I (0°, 0°)+I (90°, 0°), S₁=I (0°, 0°), −I (90°,0°), S₂=2·I (45°, 0°)−S₀, S₃=2·I (45°, π/2)−S₀.

### CROSS-REFERENCE TO RELATED APPLICATIONS

This non-provisional application claims priority under 35 U.S.C. § 119(a) on Patent Application No(s). 202010052450.0 filed in China on Jan. 17, 2020, the entire contents of which are hereby incorporated by reference.

### BACKGROUND OF THE INVENTION

### Field of the Invention

The present invention relates to a instrument for measuring polarized light 3D images and a manufacturing method thereof, and more particularly, to a instrument that replaces the design of a complicated mechanical structure with a mature panel manufacturing process and a manufacturing method thereof.

Description of the Prior Art

The polarization state of light can be used in 3D sensing, material identification, etc. To measure the polarization state of light, the conventional measurement method is shown in FIG. 1. A light source 11 passes through the refraction or reflection of a test object 12. The light sequentially passes through a quarter wave plate 13, a polarizing plate 14, a light intensity sensor 15 and a voltage sensing device 16 in order to read the final voltage value.

To describe the polarization state of polarized light requires four sets of light intensity, which are [S₀, S₁, S₂, S₃]. The measurement requires the optical axis of the quarter wave plate 13 and the polarizing plate 14 to be matched with each other. The light intensity is a combination of the polarizing plate 14 and the quarter-wave plate 13 and is defined as follows: I (polarizer rotation angle, quarter-wave plate rotation angle)=I (0°,0°), I (90°,0°), I (45°,0°), I (45°, π/2) (where: π is the diameter of a semicircle, I is the light intensity) The light intensity (I), the value of which is a function of the quarter-wave plate rotation angle and the rotation angle of the polarizing plate, is expressed as: I (polarizer rotation angle, quarter-wave plate rotation angle). The measurement process requires mechanical processing where the combination is achieved by rotating the polarizing plate 14 and changing the phase retardation of the quarter-wave plate 13.

However, during the measurement process, the polarizing plate 14 needs to be mechanically rotated and the phase retardance of the quarter-wave plate is changed in order to achieve the combination. As a result, this structure of the prior art faces at least two problems. First, a relatively large mechanical structure is required. Therefore, the overall equipment wastes space and increases costs so it does not meet the requirements of small size and low cost. Second, it takes time to wait for the mechanical structure to rotate, which causes the measurement time to be prolonged. If objects that change over time are measured, measurements will be lost or inaccurate.

From the above description it can be seen that the conventional methods still have many shortcomings. They are not well designed and need to be improved.

Therefore, the present invention replaces the design of a complicated mechanical structure with a mature panel manufacturing process.

### SUMMARY OF THE INVENTION

In view of the above, the inventor of the present invention has been engaged in the design, manufacturing, and development of related products for many years. After detailed design and careful evaluation of the objectives, the present invention has finally become practical.

An object of the present invention is to provide a instrument for measuring polarized light 3D images and a manufacturing method thereof. The present invention utilizes a panel manufacturing process instead of a complicated mechanical structure to produce superior benefits over the conventional measurement methods.

According to the above object and more, the instrument for measuring polarized light 3D images of the present invention mainly comprises: an image sensor, a liquid crystal cell, and a polarizing plate; wherein the liquid crystal cell is located above the image sensor. The liquid crystal cell has at least four pixel areas, namely a first pixel area, a second pixel area, a third pixel area, and a fourth pixel area. The liquid crystal cell is composed of two sheets of glass and a liquid crystal where the two sheets of glass are respectively adhered to the upper and lower surfaces of the liquid crystal. The phase retardance of the first pixel area, the second pixel area and the third pixel area is Γ=0, and the phase retardance of the fourth pixel area Γ=π/2. The polarizing plate is sandwiched between the image sensor and the liquid crystal cell. The polarizing plate is divided into at least four quadrants, comprising a first quadrant, a second quadrant, a third quadrant, and a fourth quadrant. The polarizer angle of the first quadrant is 90 degrees, the polarizer angle of the second quadrant is 0 degrees, the polarizer angle of the third quadrant is 45 degrees, and the polarizing angle of the fourth quadrant is 45 degrees. The design comprises a combination of a quarter-wave plate and a polarizing plate simultaneously fabricated on the image sensor. When the polarization state of the light is sensed using the polarized light 3D image measuring instrument of the present invention, the image sensor captures the four parameters S₀, S₁, S₂, S₃ which are used to calculate the Stokes parameters, which are S₀=I (0°, 0°)+I (90°, 0°), S₁=I (0°,0°)−I (90°, 0°), S₂=2˜I (45°, 0°)S₀, S₃=2·I (45°, π/2).

The light intensity required for the four sets of parameters such as S₀(where: π is the diameter of a semicircle and I is the light intensity), is used in the measurement process.

It is not necessary to mechanically rotate the polarizing plate and change the phase retardance of the quarter-wave plate to achieve the superior benefits of the combination of light intensity required for the four sets of parameters S₀, S₁, S₂, and S₃ during measurement. Therefore, a large mechanical structure is not needed which meets the requirements of small size and low cost. At the same time, the need to wait for the mechanical structure to rotate is not necessary thereby eliminating prolonged measurement time and loss of measurement accuracy.

### BRIEF DESCRIPTION OF THE DRAWINGS

To further understand and understand the purpose, shape, structure and function of the present invention, the present invention will be described in detail and illustrated in the drawings as follows:

FIG. 1 is a drawing illustrating a measurement method of polarization state of light sensing of the prior art;

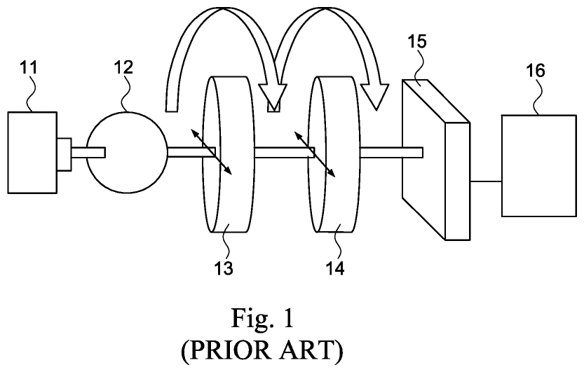

FIG. 2A is a drawing illustrating a instrument for measuring polarized light 3D images according to an embodiment of the present invention;

FIG. 2B is a drawing illustrating a instrument for measuring polarized light 3D images according to an embodiment of the present invention;

FIG. 3A is a drawing illustrating a manufacturing method of a instrument for measuring a polarized light 3D image according to an embodiment of the present invention;

FIG. 3B is a drawing illustrating a manufacturing method of a instrument for measuring a polarized light 3D image according to an embodiment of the present invention;

FIG. 4A is a drawing illustrating a manufacturing method of the polarized light 3D image measuring instrument according to an embodiment of the present invention;

FIG. 4B is a drawing illustrating a manufacturing method of the polarized light 3D image measuring instrument according to an embodiment of the present invention;

FIG. 5 is a drawing illustrating use of a instrument for measuring polarized light 3D images according to an embodiment of the present invention; and

FIG. 6 is a drawing illustrating use of the polarized light 3D image measuring instrument according to an embodiment of the present invention.

### DESCRIPTION OF THE PREFERRED EMBODIMENTS

The present invention provides an instrument for measuring 3D polarized light and its manufacturing method.

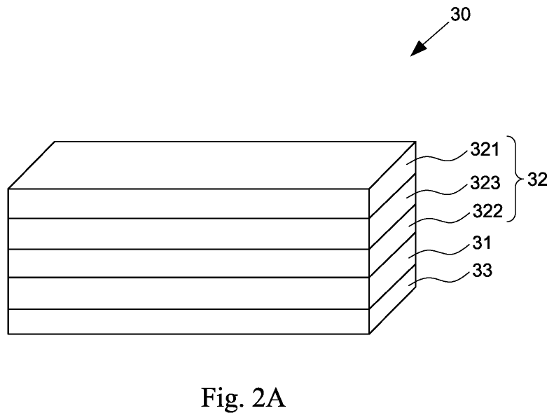

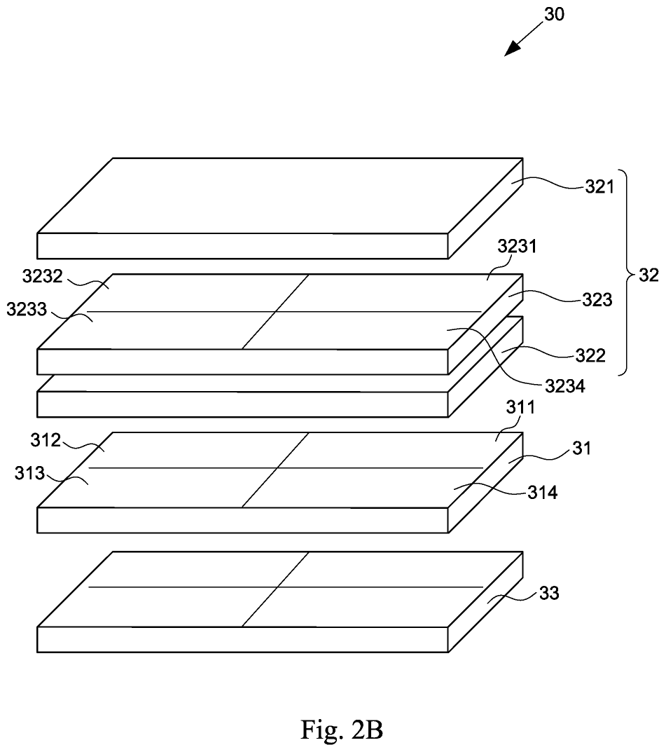

Refer to FIGS. 2A and 2B. The instrument 30 for measuring 3D polarized light according to the present invention mainly comprises a polarizing plate 31, a liquid crystal cell 32, and an image sensor 33.

The polarizing plate 31 is disposed on the image sensor 33. The polarizing plate 31 is divided into at least four quadrants, comprising a first quadrant 311, a second quadrant 312, a third quadrant 313, and a fourth quadrant 314. The polarizer angle Θ of the first quadrant 311 is 90 degrees, the polarizer angle Θ of the second quadrant 312 is 0 degrees, the polarizer axis angle Θ of the third quadrant 313 is 45 degrees, and the polarizer axis angle Θ of the fourth quadrant 314 is 45 degrees.

The liquid crystal cell 32 is disposed on the polarizing plate 31, and the polarizing plate 31 is sandwiched between the liquid crystal cell 32 and the image sensor 33. The liquid crystal cell 32 comprises at least four pixel areas, a first pixel area 3231, a second pixel area 3232, a third pixel area 3233, and a fourth pixel area 3234. The liquid crystal cell 32 is composed of two sheets of glass 321, 322, and a liquid crystal 323. The two pieces of glass 321 and 322 are respectively adhered to the upper and lower surfaces of the liquid crystal 323. The phase retardance of the first pixel area 3231, the second pixel area 3232, and the third pixel area 3233 are Γ=0, and the phase retardance of the fourth pixel area 3234 is Γ=π/2 (where: π is the diameter of a semicircle).

Based on the composition of the above components, by designing the combination of four quarter wave plates and the polarizing plate on the image sensor 33 at the same time, when the polarization state of the light is sensed, the image sensor 33 captures a detection picture and integrates the four quadrants 311, 312, 313, and 314 to calculate different Stokes parameters S₀, S₁, S₂, S_{3,} which are S₀=I (0°, 0°)+I (90°, 0°), S₁=I (0°, 0°)−I (90°, 0°), S₂=2·I (45° (polarizer angle), 0° (quarter wave plate angle)), S₃=2·I (45° (polarizer angle), π/2 (quarter wave plate angle)).

The light intensity required for the four sets of parameters such as S₀(where: π is the diameter of a semicircle and I is the light intensity) is used during the measurement process.

It is not necessary to mechanically rotate the polarizing plate and change the phase retardation of the quarter wave plate to achieve superior benefits to obtain the combination of light intensity required for the four sets of parameters S₀, S₁, S₂, and S₃, during measurement. As a result, a large mechanical structure is not necessary so the requirements of small size and low cost are met, and also waiting for the mechanical structure to rotate is not needed which eliminates prolonged measurement time and measurement inaccuracy.

The four pixel areas 3231, 3232, 3233, and 3234 of the liquid crystal cell 32 respectively correspond to the four quadrants 311, 312, 313, and 314 of the polarizing plate 31.

The image sensor 33 is provided with a wire grid polarizer (not shown), and the wire grid polarizer is divided into at least four sensing areas, where the optical axis direction of the sensing areas correspond to the four quadrants 311, 312, 313, and 314.

The image sensor 33 comprises an array type photosensitive coupling element (CCD) or an array type complementary metal oxide semiconductor (CMOS).

The pixel areas 3231, 3232, 3233, and 3234 are respectively provided with electrode layers (not shown) on both sides thereof, and the pixel regions 3231, 3232, 3233, and 3234 are respectively driven via these electrode layers.

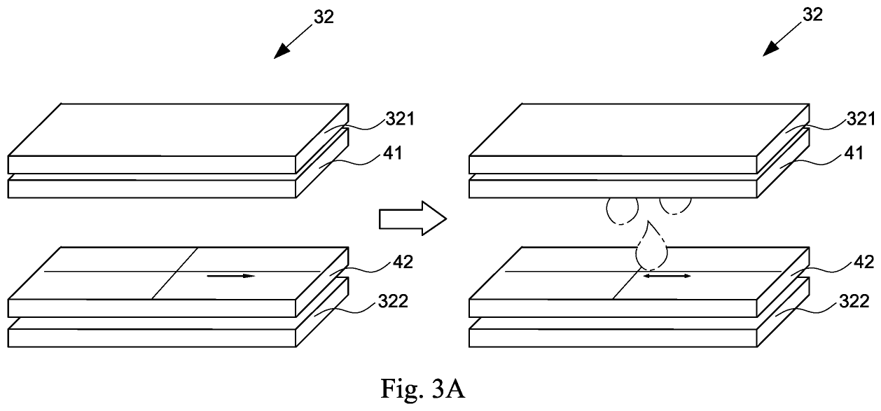

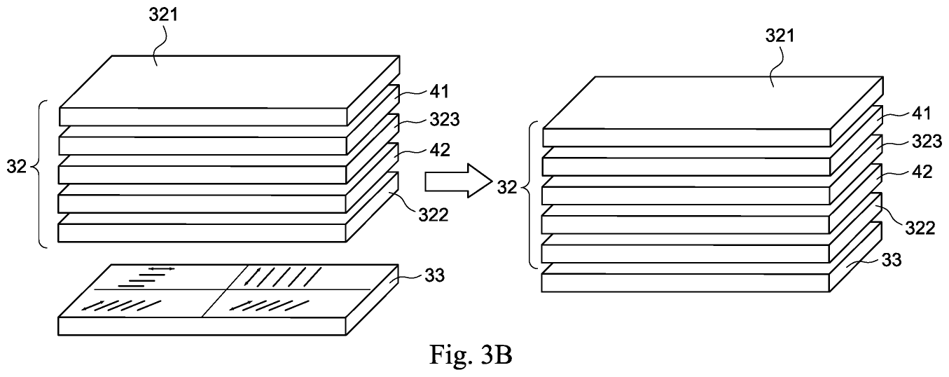

Refer to FIG. 3A and FIG. 3B. The manufacturing method of the 3D image measuring instrument of polarized light according to the present invention, provides a panel manufacturing process to simultaneously produce four types of quarter wave plates and a polarizing plate combination above the image sensor 33 (for example, an array-type photosensitive coupling element (CCD) or an array-type complementary metal oxide semiconductor (CMOS)). The processing flow is according to the following steps:

Step 1. Fabricate the upper and lower plates 41 and 42 of a liquid crystal cell 32, respectively, and apply a guiding polymer material (PI) and align it. The direction of the alignment is as shown in the figures.

Step 2. The liquid crystal 323 is coated by using a drop-injection (ODF) process. In this embodiment, a positive type liquid crystal (E7) is used. The birefringence An is 0.2236, and the liquid crystal cell gap is 3 um.

Step 3. After the upper and lower plates 41, 42 of the liquid crystal cell 32 are sealed, heat up until the liquid crystal alignment is completed.

Step 4. A wire grid polarizer is fabricated on the image sensor 33 (for example, an array-type photosensitive coupling element (CCD) or an array-type complementary metal oxide semiconductor (CMOS)) pixel using a yellow light process, where the period (Pitch) is 140 nm, and the line width/space (line/space) is 70 nm.

Step 5. Bond the liquid crystal cell 32 on the image sensor 33 to achieve a phase retardance Γ=π/2 (where π is pi) in the fourth quadrant by means of alignment.

Refer to FIGS. 2A, 2B, 3A, and 3B. The liquid crystal cell 32 has at least four pixel areas or regions, namely a first pixel area 3231, a second pixel area 3232, third pixel area 3233, and a fourth pixel area 3234. An alignment layer is provided thereon to delay the phase of the first pixel area 3231, the second pixel area 3232, and the third pixel area 3233 where Γ=0, and the phase retardance of the fourth pixel area 3234 is Γ=π/2.

The liquid crystal cell 32 has at least four pixel areas, namely a first pixel area 3231, a second pixel area 3232, a third pixel area 3233 and a fourth pixel region 3234. An electrode layer (not shown) is arranged above and below the pixel areas 3231, 3232, 3233, and 3234, respectively, and a voltage is applied. The phase retardance of the first pixel area 3231, the second pixel area 3232, and the third pixel area 3233 is Γ=0, and the phase retardance of the fourth pixel area 3234 is Γ=π/2.

A polarizing plate 31 is sandwiched between the image sensor 33 and the liquid crystal cell 32. The polarizing plate 31 is divided into at least four quadrants 311, 312, 313, and 314, including a first quadrant 311, a second quadrant 312, and a third quadrant 313 and a fourth quadrant 314. The polarizer angle of the first quadrant 311 is 90 degrees, the polarizer angle of the second quadrant 312 is 0 degrees, the polarizer angle of the third quadrant 313 is 45 degrees, and the polarizer angle of the fourth quadrant 314 is 45 degrees. The wire grid polarizer region (not shown) is divided into at least four sensing regions, and the optical axis direction including the four sensing regions corresponds to the four quadrants. 311, 312, 313, 314.

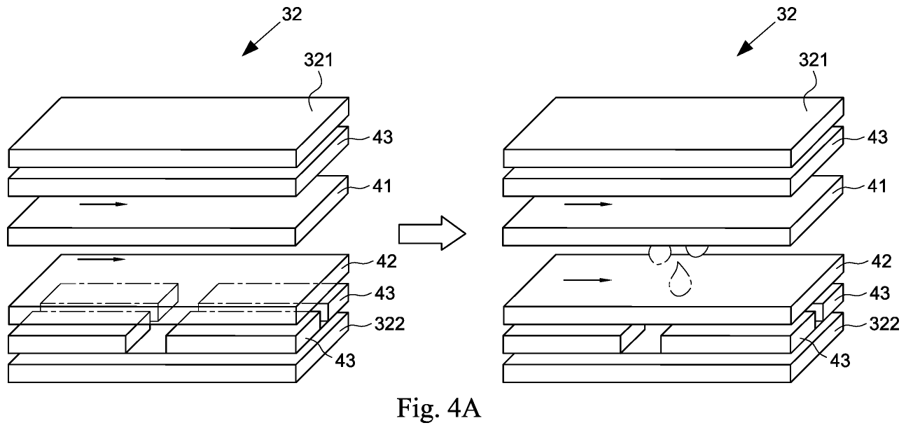

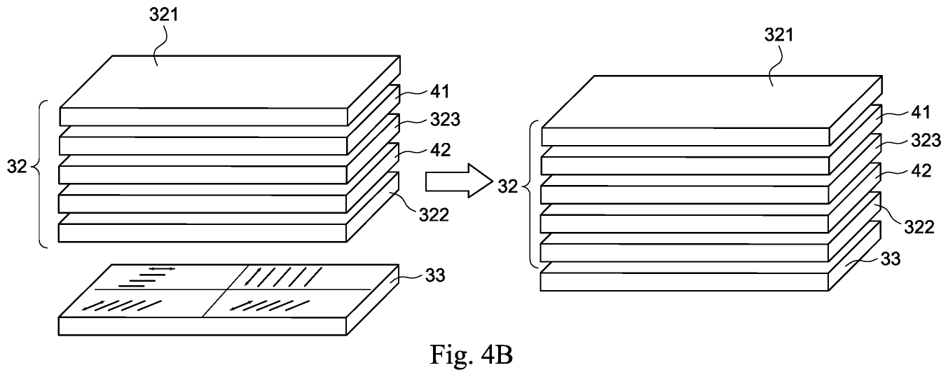

Refer to FIG. 4A and FIG. 4B. Another manufacturing method of the instrument for measuring 3D image of polarized light according to the present invention is achieved using a phase retardance of the fourth quadrant by applying a voltage Γ=π/2 (where: π is the circumference), using a panel manufacturing process, adding a transparent conductive electrode (ITO) 43, and combining four measuring quarter wave plates and a polarizing plate above the image sensor 33, for example, an array type photoreceptor, a coupling element (CCD) or array-type complementary metal oxide semiconductor (CMOS) (as shown in FIG. 4A). The processing flow is according to the following steps:

Step 1. Fabricate the upper and lower plates 41 and 42 of a liquid crystal cell 32, respectively, and apply a guiding polymer material (PI) and align it. The direction of the alignment is as shown in the figure.

Step 2. The liquid crystal 323 is coated by using a drop-injection (ODF) process. In this embodiment, a positive type liquid crystal (E7) is used. The birefringence Δn is 0.2236, and the liquid crystal cell gap is 3 um. The liquid crystal 323 can be configured in the same direction, but is divided into four independent blocks for driving. Three of the applied voltages cause the liquid crystal 323 to be arranged vertically on the substrate, and the fourth applied voltage achieves the effect of a quarter wave plate.

Step 3. After the liquid crystal cell 32 is sealed, heat up until the liquid crystal alignment is completed.

Step 4. A wire grid polarizer is fabricated on the image sensor 33 (for example, an array-type photosensitive coupling element (CCD) or an array-type complementary metal oxide semiconductor (CMOS)) in a yellow light process where the period (Pitch) is 140 nm, and the line width/space (line/space) is 70 nm.

Step 5. Bonding the image sensor 33 and the liquid crystal cell 32 to achieve a phase retardance of the fourth quadrant by applying a voltage Γ=π/2 (where: π is the circumference).

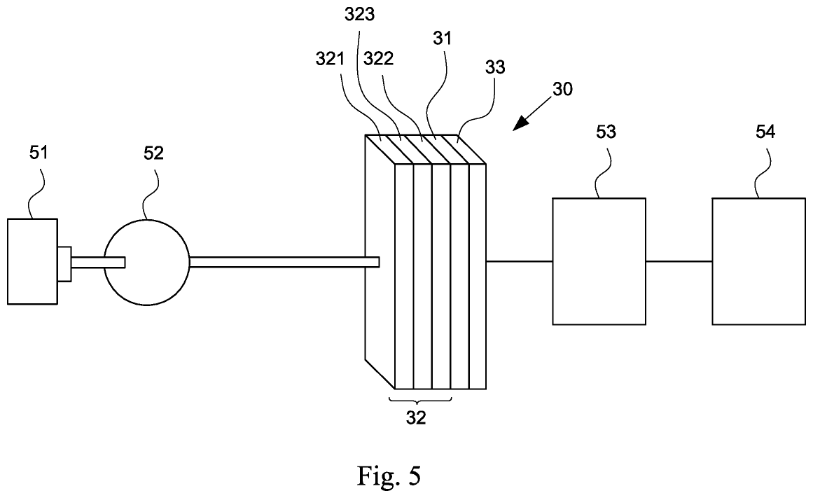

Refer to FIG. 5. The instrument for measuring polarized light 3D images of the present invention detects the polarization state of light. A light source 51 is refracted or reflected by an object to be measured 52, and then sequentially after via the polarized light 3D image measurement instrument 30 of the present invention, a signal processor 53, and a personal computer 54. The personal computer 54 finally reads and analyzes the signal value of the signal processor 53, so that it can directly receive the light source and make a single point measurement and sense four kinds of light intensity at the same time.

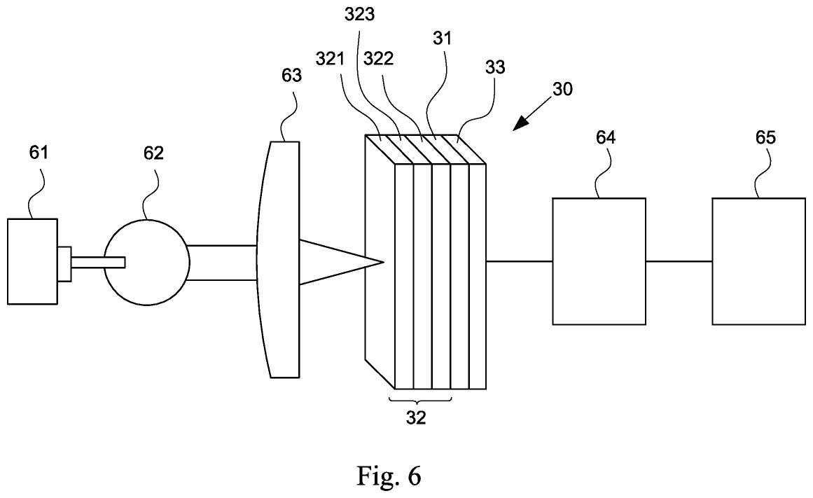

Refer to FIG. 6. Another way of sensing the polarization state of light using the polarized light 3D image measuring instrument of the present invention is to make a light source 61 pass through the refraction or reflection of a test object 62. The light is then focused by a lens 63, and then sequentially passes through the polarized light 3D image measuring instrument 30 of the present invention, a signal processor 64, and a personal computer 65. The personal computer 65 finally reads and analyzes the signal processing.

In this way, the signal value of the detector 64 can be matched with the lens 63 to form an image of the object to be measured 62 above the image sensor 33, measure the images one at a time, and simultaneously obtain the polarization distribution image, with four pixels as the smallest unit but expandable in a matrix manner.

The above description comprises the best embodiments of the present invention, but the structural features of the present invention are not limited thereto, and any change or modification that can be easily considered by those skilled in the art can be covered.

What is claimed is:

1. An instrument for measuring polarized light 3D images, comprising:
an image sensor;
a liquid crystal cell disposed above the image sensor, the liquid crystal cell comprising at least four pixel areas, namely a first pixel area, a second pixel area, a third pixel area, and a fourth pixel area;
wherein phase retardance of the first pixel area, the second pixel area, and the third pixel area is Γ=0, and phase retardance of the fourth pixel area is Γ=π/2; and
a polarizing plate disposed between the image sensor and the liquid crystal cell, the polarizing plate divided into at least four quadrants, including a first quadrant, a second quadrant, a third quadrant and a fourth quadrant;
wherein polarizer angle in the first quadrant is 90 degrees, polarizer angle in the second quadrant is 0 degrees, polarizer angle in the third quadrant is 45 degrees, and polarizer angle in the fourth quadrant is 45 degrees; and
wherein when a polarization state of light is sensed, the image sensor captures a detection frame and synthesizes the at least four quadrants to calculate different Stokes parameters.

2. The instrument for measuring polarized light 3D images of claim 1, wherein the at least four pixel areas of the liquid crystal cell correspond to the at least four quadrants of the polarizing plate.

3. The instrument for measuring polarized light 3D images of claim 1, wherein a wire grid polarizer is provided on the image sensor, and the wire grid polarizer is divided into at least four sensing regions, and optical axis direction containing the at least four sensing regions corresponds to the at least four quadrants.

4. The instrument for measuring polarized light 3D images of claim 1, wherein the image sensor is an array-type photosensitive coupling element (CCD) or an array-type complementary metal oxide semiconductor (CMOS).

5. The instrument for measuring a polarized light 3D image of claim 1, wherein the at least four pixel areas are respectively provided with an electrode layer on both sides thereof, and the electrode layers drive the at least four pixel areas separately.

6. A method for manufacturing a instrument for measuring polarized light 3D images comprising:
fabricating an upper plate and a lower plate on a liquid crystal cell, respectively, applying a guiding polymer material (PI), and aligning in one direction;
coating a liquid crystal by using a drop injection (ODF) process;
after the liquid crystal cell is sealed, heating up the upper plate and the lower plate until alignment of the liquid crystal is completed;
fabricating a wire grid polarizer on an image sensor in a yellow light process; and
adhering the liquid crystal cell on the image sensor.

7. The method for manufacturing a instrument for measuring a polarized 3D image of claim 6, wherein the liquid crystal cell has at least four pixel areas, namely a first pixel area, a second pixel area, a third pixel area, and a fourth pixel area, and an alignment layer is provided on the pixel areas to align phases, where phase retardance of the first pixel area, the second pixel area, and the third pixel area is Γ=0, and phase retardance of the fourth pixel area is Γ=π/2.

8. The method for manufacturing a instrument for measuring a polarized 3D image of claim 6, wherein the liquid crystal cell has at least four pixel areas, namely a first pixel area, a second pixel area, a third pixel area, and a fourth pixel area, and an electrode layer is respectively arranged above and below the pixel area to provide a voltage to make phase retardance of the first pixel area, the second pixel area, and the third pixel area be Γ=0, and phase retardance of the fourth pixel area be Γ=π/2.

9. The manufacturing method of a instrument for measuring a polarized 3D image of claim 7, wherein a polarizing plate is disposed between the liquid crystal cell and the image sensor, and the polarizing plate comprises at least four quadrants comprising a first quadrant, a second quadrant, a third quadrant, and a fourth quadrant, where polarizer angle of the first quadrant is 90 degrees, polarizer angle of the second quadrant is 0 degrees, polarizer angle of the third quadrant is 45 degrees, and polarizer angle of the fourth quadrant is 45 degrees, wherein a wire grid polarizer is divided into at least four sensing regions with optical axis directions of the at least four sensing regions corresponding to the at least four quadrants.
